(19) United States
(12) Patent Application Publication
(10) Pub. No.: US 2026/0105285 A1
(43) Pub. Date: Apr. 16, 2026

(54) ACCURACY DETERMINATION FOR GENERATIVE AI ENGINES

(71) Applicant: Kyndryl, Inc., New York, NY (US)

(72) Inventors: Cesar Augusto Rodriguez Bravo, Alajuela (CR); Ilyas Iyoob, Pflugerville, TX (US); Venkatapurna Parthasarathy Madhira, Frisco, TX (US); Omar Odibat, Cedar Park, TX (US)

(21) Appl. No.: 18/914,517

(22) Filed: Oct. 14, 2024

(51) Int. Cl. G06N 3/0475; G06N 3/045

(52) U.S. Cl. CPC G06N 3/0475; G06N 3/045

(57) ABSTRACT

Embodiments relate to providing an accuracy determination for generative AI engines, along with selection and execution of accurate generative AI engines. An aspect includes receiving a user prompt for execution and determining a characteristic of the user prompt. AI engines have a relationship to the characteristic. An aspect includes inputting the user prompt to at least one AI engine of the AI engines in accordance with the characteristic, such that a response is received from the at least one AI engine. An aspect includes presenting the response.

### BACKGROUND

The present invention generally relates to computer systems, and more specifically, to computer-implemented methods, computer systems, and computer program products configured and arranged to provide an accuracy determination for generative artificial intelligence (AI) engines, along with selection and execution of accurate generative AI engines.

AI is in the field of computer science relating to the development of computer systems for performing tasks that typically require human intelligence, such as speech recognition, natural language processing (NLP), text generation and translation, video, sound, and image generation, decision making, planning, and more. In general, AI refers to the development of intelligent systems that can mimic human behavior and decision-making processes. AI encompasses techniques and approaches enabling machines to perform tasks, analyze visual and textual data, and respond or adapt to their environment. One of the benefits of artificial intelligence is its ability to process large amounts of data and find patterns in it. As such, AI tools are designed to make decisions or take actions based on that knowledge.

### SUMMARY

Embodiments of the present invention are directed to computer-implemented methods for providing an accuracy determination for generative artificial intelligence (AI) engines, along with selection and execution of accurate generative AI engines. A non-limiting computer-implemented method includes receiving a user prompt for execution and determining a characteristic of the user prompt. Artificial intelligence engines have a relationship to the characteristic. The method includes inputting the user prompt to at least one AI engine of the AI engines in accordance with the characteristic, such that a response is received from the at least one AI engine. The method includes presenting the response.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to provide an accuracy determination for generative artificial intelligence (AI) engines, by dynamically selecting and executing the most accurate generative AI engines and presenting the responses of the generative AI engines according to one or more embodiments of the present invention;

FIG. 3 depicts a flowchart of a computer-implemented method for dynamically generating an accuracy score/probability by domain for generative AI engines according to one or more embodiments of the present invention;

FIG. 4 depicts a flowchart of a computer-implemented method for providing an accuracy determination for generative artificial intelligence engines, by dynamically selecting and executing the most accurate generative AI engines and presenting the responses of the generative AI engines according to one or more embodiments of the present invention;

FIG. 5 depicts a flowchart of a computer-implemented method for dynamically providing an accuracy determination for generative AI engines according to output type, by selecting and executing the most accurate generative AI engines by output type and presenting the responses of the generative AI engines to the user according to one or more embodiments of the present invention;

FIG. 6 depicts a block diagram of an example of using dynamic accuracy thresholds based on the domain of the user prompt according to one or more embodiments of the present invention;

FIG. 7 depicts a block diagram of an example using dynamic accuracy thresholds based on the role of the user making the user prompt according to one or more embodiments of the present invention;

FIG. 8 depicts a block diagram of an example using dynamic accuracy thresholds based on the organization of the user making the user prompt according to one or more embodiments of the present invention;

FIG. 9 depicts a block diagram of an example using dynamic accuracy thresholds based on the location of the user making the user prompt according to one or more embodiments of the present invention;

FIG. 10 depicts example scores/probabilities of accuracy for generative AI engines according to one or more embodiments of the present invention;

FIG. 11 depicts example scores/probabilities of accuracy for generative AI engines according to one or more embodiments of the present invention;

FIG. 12 depicts a flowchart of a computer-implemented method for dynamically filtering AI responses, thereby providing output-based analysis according to one or more embodiments of the present invention;

FIG. 13 depicts a flowchart of a computer-implemented method for dynamically filtering AI responses, thereby providing output-based analysis according to one or more embodiments of the present invention;

FIG. 14 depicts a flowchart of a computer-implemented method for dynamically providing an accuracy determination for generative AI engines, by selecting and executing the most accurate generative AI engines and presenting the responses of the generative AI engines according to one or more embodiments of the present invention;

FIG. 15 depicts a cloud computing environment according to one or more embodiments of the present invention; and

FIG. 16 depicts abstraction model layers according to one or more embodiments of the present invention.

### DETAILED DESCRIPTION

One or more embodiments are configured and arranged to dynamically provide an accuracy determination for generative artificial intelligence (AI) engines, along with selection and execution of accurate generative AI engines on behalf of a user. Generative AI engines can generate output having hallucinations, which are inaccuracies. One or more embodiments provide a system that ingests identified hallucinations and categorizes those hallucinations (or inaccuracies) according to domains of the user prompt. Examples of categories for the domains may be area of expertise (e.g., legal, engineering, information technology (IT), etc.), topic (e.g., history, math, science, etc.), output type (e.g., text, summary, bullets, tables, links, etc.), etc.

There are various providers of generative AI engines, and each generative AI engine has its own strengths and weaknesses. A common issue with generative AI engines is inaccurate results or hallucinations. AI hallucination is a phenomenon where a language model (such as large language model (LLM)) perceives patterns or objects that are nonexistent or imperceptible to human observers, creating outputs that are nonsensical or altogether inaccurate. Organizations may seek to implement generative AI solutions in their businesses, but inaccurate results could hinder their implementation.

One or more embodiments provide a system as a data classification layer between the user and a variety of generative AI engines in order to select the best generative AI engines for the specific task. The overall system can be implemented as a standalone device and/or as a cloud service. This system automatically improves the accuracy of the results of the generative AI engines.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

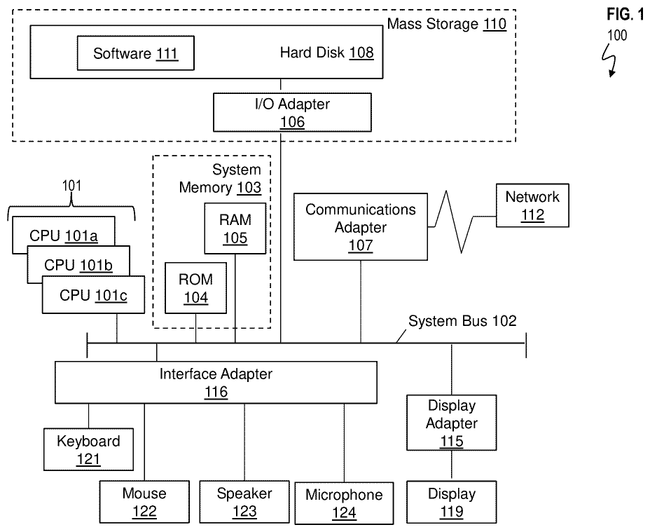

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program products and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

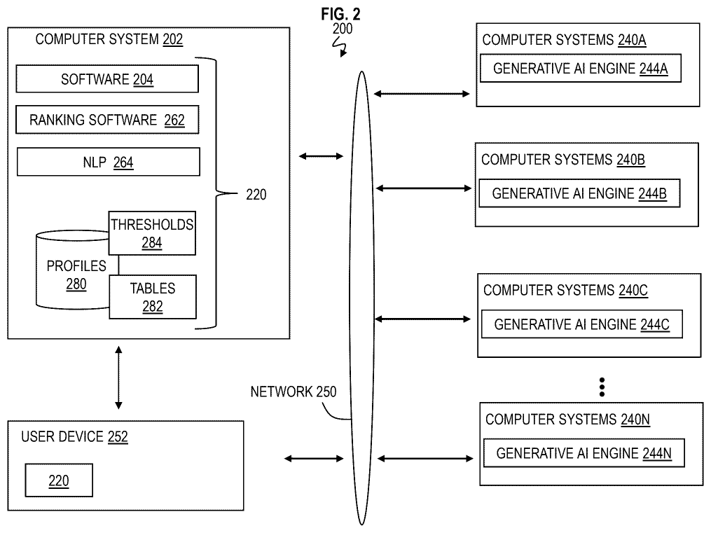

FIG. 2 depicts a block diagram of an example system 200 configured to provide an accuracy determination for generative artificial intelligence (AI) engines, by selecting and executing the most accurate generative AI engines and then presenting the responses of the generative AI engines to the user. The system 200 includes a computer system 202 configured to communicate over a network 250 with many different computer systems, such as a computer system 240A, a computer system 240B, through a computer system 240N. The computer system 240A, the computer system 240B, through the computer system 240N can generally be referred to as computer systems 240.

The computer system 202 is configured to communicate with a user device 252 over a network, which could be wireless and/or wired communication network. Although a single user device 252 is illustrated in FIG. 2, the user device 252 can represent numerous user devices connected to the computer system 202. The user device 252 can be a personal computer or laptop. The user device 252 can be a mobile device such as a cellular phone or tablet or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The computer systems 240 can include various software and hardware components including software applications (apps) for communicating over the network 250 as understood by one of ordinary skill in the art. The computer systems 240A, 240B, and 240N can include generative AI engines 244A, 244B, and 244N, respectively to provide generative AI services. The generative AI engines 244A, 244B, and 244N can generally be referred to as generative AI engines 244.

The computer system 202, computer systems 240, user device 252, software 204, ranking software 262, etc., can include functionality and features of the computer system 100 in FIG. 1 including various hardware components and various software applications such as software 111 which can be executed as instructions on one or more processors 101 in order to perform actions according to one or more embodiments of the invention. The software 204 can include, be integrated with, and/or call other pieces of software, algorithms, application programming interfaces (APIs), graphical user interfaces (GUIs) etc., to operate as discussed herein.

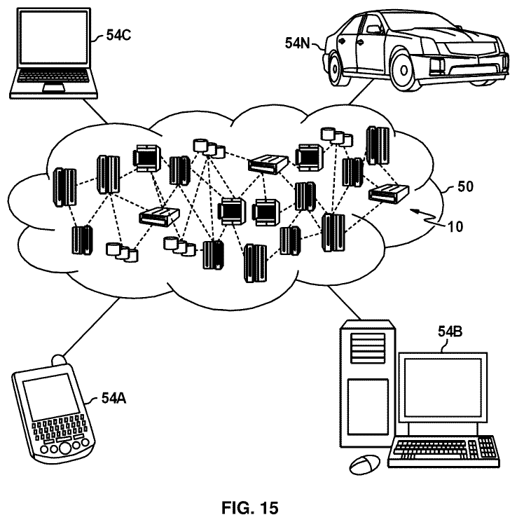

The computer system 202 may be representative of numerous computer systems and/or distributed computer systems configured to provide security services to users of the computer systems 240. The computer system 202 can be part of a cloud computing environment such as a cloud computing environment 50 depicted in FIG. 15, as discussed further herein.

Generative AI engines use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. Generative AI is trained to learn human language, programming languages, art, chemistry, biology, or any complex subject matter. Generative AI reuses training data to solve new problems. For example, it can learn the English vocabulary and create a poem from the words it processes. An organization can use generative AI for various purposes. Like all artificial intelligence, generative AI works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as such as summarization, text generation, classification, open-ended conversation, and information extraction.

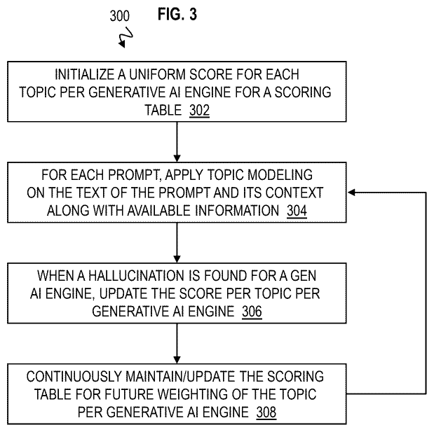

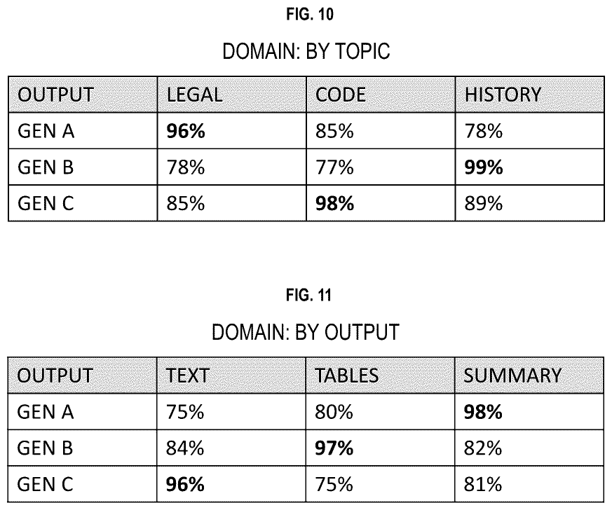

FIG. 3 depicts a flowchart of a computer-implemented method 300 for generating an accuracy score/probability by domain for generative AI engines according to one or more embodiments. The accuracy score may decrease each time a hallucination/inaccuracy is found. The software 204 may employ a ranking software 262 to generate the accuracy scores for numerous generative AI engines. It should be appreciated that, although an example ranking algorithm is discussed herein, other ranking algorithms can be utilized to account for decreasing the accuracy score of generative AI engines when their responses contain a hallucination/inaccuracy for a given domain. The domains represent categories for user prompts over which the generative AI engines are evaluated for accuracy and correctness. Example domains may be categorized by area of expertise including, for example, legal engineering, IT, etc. A domain may be categorized by topic including, for example, history, math, science, etc. Because some generative AI engines are multimodal in their output, a domain can be categorized by output including, for example, output in text, output in tables, output in summary, etc. Further, example domains are not meant to be limited and may overlap and can include any subject matter. The domains represent a discernable characteristic of the user prompt. Example scoring tables 282 of domains are depicted in FIGS. 10 and 11. Further details of the rating/scoring for the generative AI engines are discussed below.

At block 302 of the computer-implemented method 300, the software 204 is configured to cause the ranking software 262 to initialize a uniform score for each topic per a generative AI engine. For example, Score (engine, topic)=S. The accuracy scores of each of the generative AI engines per topic can be initialized to, for example, 100% accuracy. Although the score may be initialized to 100%, it should be appreciated that other values can be utilized.

At block 304, for each user prompt, the software 204 is configured to apply topic modeling on the text of the user prompt and its context along with available information. The software 204 may utilize NLP 264 to derive/summarize the topic of the user prompt. Topic modeling is a frequently used text-mining tool for discovery of hidden semantic structures in a text body. Topic models are an NLP method for summarizing text data through word groups, and they assist in text classification and information retrieval tasks. There can be various known topic modeling algorithms that may be used.

A user prompt can be input on the user device 252, which is provided to the software 204. The user device 252 can push the user prompt to the software 204 and/or the software 204 can pull the user prompt from the user device 252. The user prompt of the user device 252 may be input in a portal, a web browser, a plug in, etc., or any type of software tool.

At block 306, if a hallucination/inaccuracy is found for a given generative AI engine for the given domain of the user prompt, the software 204 is configured to update the score for the given generative AI engine for that given domain. For example, Score (engine, topic)=Score (engine, topic)−1. The accuracy score for the given generative AI engine having the hallucination/inaccuracy is decreased by any predetermined amount. Any known technique for determining hallucinations/inaccuracies can be utilized for given topics.

At block 308, the software 204 is configured to update/maintain the scoring table for future weighting of the topic per generative AI engine. The software 204 can continuously check for hallucinations/inaccuracies in the responses of generative AI engines per topic and reduce the score when they are found. This allows for the individual accuracy to be maintained per domain for each of the generative AI engines.

In FIGS. 10 and 11, the names of known generative AI engines have been anonymized. In FIG. 10, user prompts having data over various topics including legal, code (e.g., computer code), and history are utilized as the subject matter input to generative AI engines to receive a response as the output. The output responses are checked for hallucinations/inaccuracies for the given topic, and the accuracy score of a given generative AI engine having a hallucination/inaccuracy is reduced a predetermined amount for that topic. The process of scoring by topic in FIG. 10 applies by analogy to scoring by output type for the generative AI engines, because some generative AI engines perform better than others for certain types of output such as text, tables, and summary as illustrated in FIG. 11. Other output types may include video, audio (music), animation, etc.

In one or more embodiments, the scoring tables 282 may be stored in a repository 280 of AI profiles. Although scoring tables 282 are graphically depicted for illustration purposes, the accuracy scores by domains for generative AI engines can be stored in any format, such as databases, charts, graphs, text, etc.

As discussed herein, when a user enters a user prompt related to a given domain, the software 204 can determine and select the highest scored/rated generative AI engine and/or group of highest scored/rated generative AI engines(s) for the given domain in order to obtain the most accurate responses. The highest scored/rated generative AI engines can be selected by meeting or exceeding a predetermined threshold for the given domain. In one or more embodiments, thresholds 284 for given domains can be stored in the AI profiles of the repository 280. Further details are discussed below.

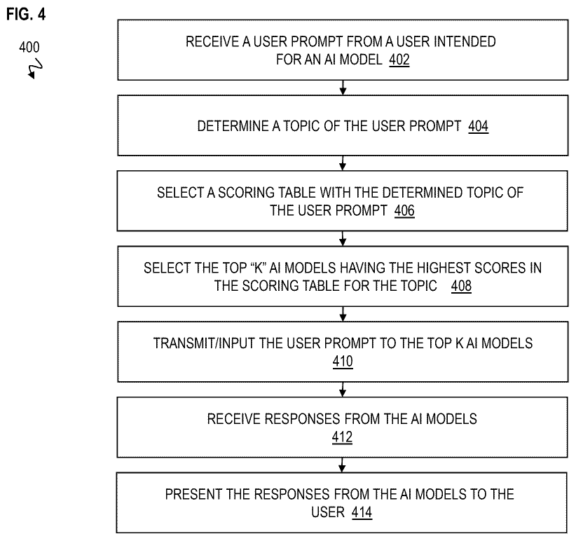

FIG. 4 depicts a flowchart of a computer-implemented method 400 for dynamically (in real-time or near real-time) providing an accuracy determination for generative AI engines, by selecting and executing the most accurate generative AI engines and then presenting the responses of the generative AI engines to the user according to one or more embodiments. This reduces the risk related to AI inaccuracies (or hallucinations) while using generative AI engines and provides accurate responses to the user device from the generative AI engines.

In one or more embodiments, the computer-implemented method 400 can be executed by the computer system 202 on behalf of and in conjunction with the user device 252. The user device 252 can communicate with the computer system 202 in order to cause the computer system 202 to assist with execution of one or more tasks, for example, in a client server relationship. The computer system 202 can return one or more responses to the user device 252, for example, by causing the user device 252 to display the responses in a graphical user interface. In one or more embodiments, the computer-implemented method 400 can be executed by the user device 252.

Software and data structures 220 can be executed on the computer system 202. One or more pieces of software and data structures 220 can be executed/used on the user device 252, on the computer system 202, and/or partly on both the user device 252 and computer system 202. Reference can be made to any figures discussed herein.

Turning to FIG. 4, at block 402 of the computer-implemented method 400, the software 204 of computer system 202 is configured to receive/capture/intercept a user prompt from the user device 252 of the of a user.

At block 404, the software 204 is configured to determine a topic of the user prompt. The software 204 may employ NLP 264 to obtain the topic of the user prompt. Any known method may be utilized to obtain the topic of the user prompt. The determined topic of the user prompt is used to match a domain. The determined topic of the user prompt may relate to coding or code, so that domain is coding or code as depicted in FIG. 10.

At block 406, the software 204 is configured to select a scoring table 282 from the AI profiles in the repository 280 with the topic of the user prompt. For example, the software 204 selects the scoring table 282 that includes accuracy scores for the domain coding or code for the different generative AI engines, as depicted in FIG. 10.

At block 408, the software 204 is configured to select the top “K” generative AI models having the highest accuracy scores in the scoring table 282 for the topic. In one or more embodiments, the value of “K” may be about 3 which means the generative AI models with the 3 highest accuracy scores are selected. In one or more embodiments, the value of “K” may be 1 which means the generative AI model with the highest accuracy score is selected. In one or more embodiments, the value of “K” may be a range. For example, the value of “K” may range from 1 to 3. In one or more embodiments, the value of “K” is adjustable. Each domain can have its own threshold 284, where some thresholds may be higher depending on the category of the domain. For example, a domain related to medical diagnosis may require a very high accuracy score/probability, such as 98% accuracy or 99% accuracy. In one or more embodiments, a threshold 284 can be set for the domain of coding or code, and generative AI models are selected having an accuracy score meeting and/or exceeding the associated threshold 284 for that domain.

At block 410, the software 204 is configured to input/transmit the user prompt to the top “K” selected generative AI models having the highest accuracy scores in the scoring table 282 for the given domain (e.g., the category of the domain is coding or code). The selected generative AI engines (e.g., generative AI engines 244 of computer systems 240) receive and process user prompts and then output their respective responses.

At block 412 and 414, the software 204 is configured to receive responses from the generative AI models and present the responses on the user device 252 of the user. The responses may be graphically displayed on the user device 252. In one or more embodiments, the software 204 can cause the user device 252 to display the responses along with an accuracy score for the respective generative AI engines having output the responses, such that the user can recognize the generative AI engines with its probability of accuracy. In one or more embodiments, the software 204 can cause the user device 252 to visually display the responses, audibly display the responses, holographically display the responses, etc., and any combination of thereof.

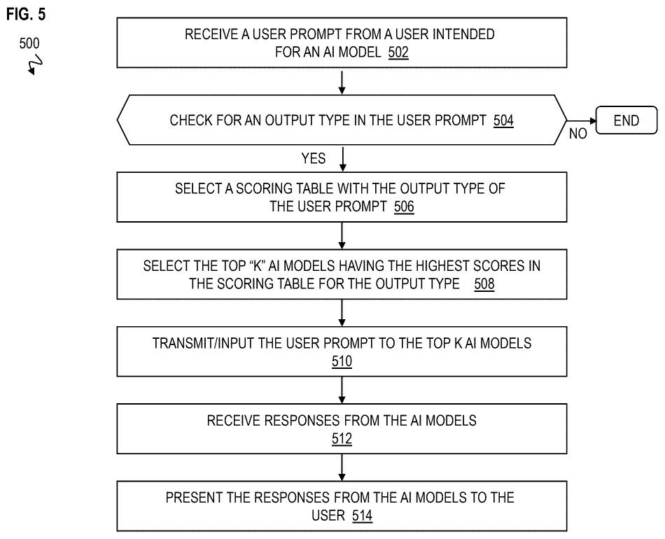

FIG. 5 depicts a flowchart of a computer-implemented method 500 for dynamically (in real-time or near real-time) providing an accuracy determination for generative AI engines according to their output type, by selecting and executing the most accurate generative AI engines by output type and then presenting the responses of the generative AI engines to the user according to one or more embodiments. FIG. 5 is analogous to FIG. 4 except the domain is changed from topic to output type.

At block 502 of the computer-implemented method 500, the software 204 of computer system 202 is configured to receive/capture/intercept a user prompt from a user device 252 of the of a user.

At block 504, the software 204 is configured to check the user prompt for an output type required in the user prompt. The software 204 may perform a search of the user prompt for known output types for generative AI engines to find a match, which may be a semantic match. The software 204 may employ NLP 264 to check the user prompt for output types. Any known method may be utilized to check the user prompt for the identification of an output type. If no output type is required or specified by the user prompt, the flow ends.

At block 506, when the output type(s) is found in the user prompt, the software 204 is configured to select a scoring table 282 with the output type of the user prompt. For example, the software 204 selects the scoring table 282 that includes accuracy scores for the domain output type for the different generative AI engines, as depicted in FIG. 11. In this scenario, an example output type may be tables.

At block 508, the software 204 is configured to select the top “K” generative AI models having the highest accuracy scores in the scoring table for the output type. As noted herein, the value of “K” may be about 3. In one or more embodiments, the value of “K” may be 1 which means the generative AI model with the highest accuracy score is selected. Also, the value of “K” may be a range in one or more embodiments. For example, the value of “K” may range from 1 to 3. In one or more embodiments, the value of “K” is adjustable. Each domain can have its own threshold 284. In one or more embodiments, a threshold 284 can be set for the domain output type of tables, and generative AI models are selected having an accuracy score meeting and/or exceeding the associated threshold 284 for that domain.

At block 510, the software 204 is configured to input/transmit the user prompt to the top “K” selected generative AI models having the highest accuracy scores in the scoring table 282 for the given domain (e.g., the category of the domain is tables). The selected generative AI engines (e.g., generative AI engines 244 of computer systems 240) receive and process user prompts and then output their respective responses.

At block 512 and 514, the software 204 is configured to receive responses from the generative AI models and present the responses on the user device 252 of the user. The responses may be graphically displayed on the user device 252. In one or more embodiments, the software 204 can cause the user device 252 to display the responses beside an accuracy score for the respective generative AI engines, such that the user can recognize the generative AI engines with their corresponding probability of accuracy for the tables.

One or more embodiments can determine the domain of the user prompt which can have both a topic (e.g., subject matter category) and output type (e.g., output category). According to one or more embodiments, when there is a conflict, the software 204 can use the top K generative AI engines for both the given topic and the given output type. In one or more embodiments, when there is a conflict, the software 204 can weigh the top K generative AI engines for the given topic more heavily than the top K generative AI engines for the given output type, or vice versa.

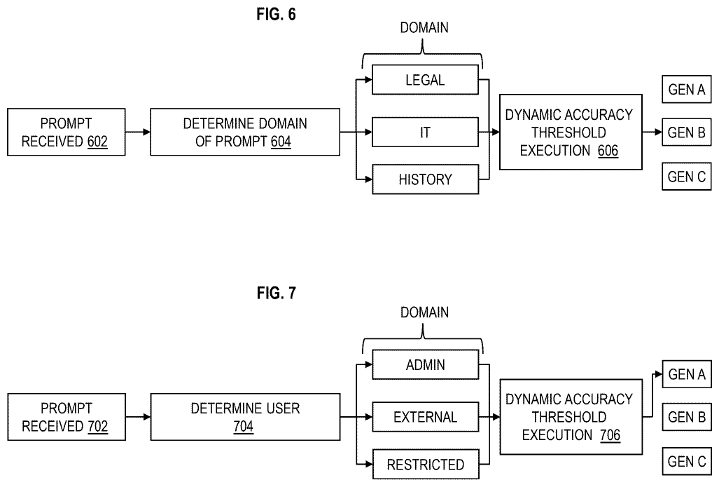

Further details of using dynamic accuracy thresholds (e.g., thresholds 284) are depicted in examples in FIGS. 6, 7, 8, and 9. In these examples, the accuracy score for a given domain is utilized with the threshold to determine when a generative AI engine is not to be included for a user prompt. This process is dynamic because it can be based on a variety of factors.

Turning to FIG. 6, a block diagram depicts an example of using dynamic accuracy thresholds based on the domain of the user prompt. At blocks 602 and 604, the software 204 receives a user prompt and determines the domain of the user prompt. At block 606, for the given domain, the software 204 selects the corresponding threshold 284 and executes a comparison of the accuracy scores for the given domain to the corresponding threshold 284. The software 204 selects the generative AI engine (e.g., generative AI engine B) that meets and/or exceeds the threshold 284. As an example scenario, it may be assumed that a person from a legal department is making a legal prompt, and accordingly, the corresponding threshold 284 can be set to (only) send the user prompt to generative AI engines with an accuracy score above 95% for the domain legal. Another domain may be the category of medical information, and the medical domain can require an accuracy score meeting and/or exceeding 98% or 99%.

FIG. 7 depicts a block diagram of an example using dynamic accuracy thresholds based on the role of the user making the user prompt. At blocks 702 and 704, the software 204 receives a user prompt and determines the role and/or type of user making the user prompt. At block 706, for the given role of the user, the software 204 selects the corresponding threshold 284 and executes a comparison of the accuracy scores for the given domain to the corresponding threshold 284. The software 204 selects the generative AI engine (e.g., generative AI engine A) that meets and/or exceeds the threshold 284. As an example scenario, it is assumed that a person making the user prompt is in the role of an administrative assistant, and accordingly, the corresponding threshold 284 can be set to (only) send the user prompt to generative AI engines with an accuracy score that meets and/or exceeds a predetermined amount.

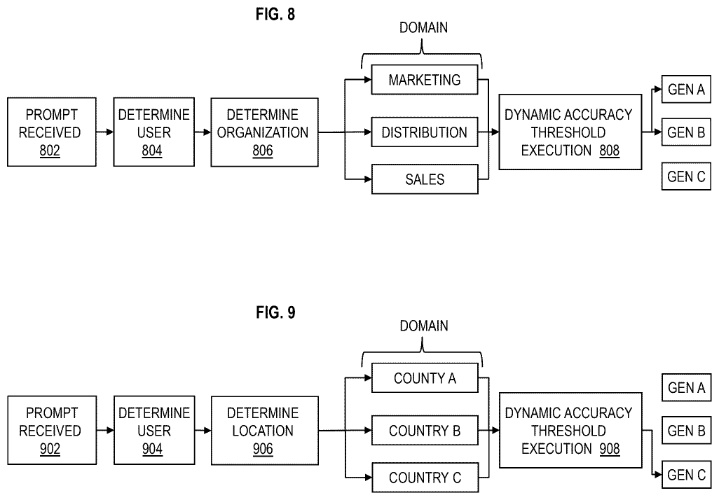

FIG. 8 depicts a block diagram of an example using dynamic accuracy thresholds based on the organization of the user making the user prompt. At blocks 802, 804, and 806, the software 204 receives a user prompt, determines who is the user, and determines the organization of the user. In one or more embodiments, the software 204 may query the name of the user in an organizational chart or the name may be in metadata associated with the user prompt. At block 808, for the given organization of the user, the software 204 selects the corresponding threshold 284 and executes a comparison of the accuracy scores for the given domain of the organization for the generative AI engines to the corresponding threshold 284. The software 204 selects the generative AI engine (e.g., generative AI engines A and B) that meets and/or exceeds the threshold 284. As an example scenario, it is assumed that the person making the user prompt is in the marketing department, and accordingly, the corresponding threshold 284 can be set to (only) send the user prompt to generative AI engines with an accuracy score that meets and/or exceeds a predetermined amount.

FIG. 9 depicts a block diagram of an example using dynamic accuracy thresholds based on the location of the user making the user prompt. At blocks 902, 904, and 906, the software 204 receives a user prompt, determines who is the user, and determines the location of the user. In one or more embodiments, the software 204 can query the name of the user in an organizational chart to determine the location of the user, which could be a remote working location. In one or more embodiments, the software 204 may use the internet protocol (IP) address of the user device 252 to obtain the location of the user. Any known technique can be utilized to obtain the location of the user. At block 908, for the given location of the user, the software 204 selects the corresponding threshold 284 and executes a comparison of the accuracy scores for the given location for the generative AI engines to the corresponding threshold 284. The software 204 selects the generative AI engine (e.g., generative AI engine C) that meets and/or exceeds the threshold 284 for requirements given location.

There are computing costs associated with each call (query) to perform a task for each generative AI engine. For example, the user prompts are requests that require computing resources including CPU usage, memory usage, network bandwidth, electrical power, etc. The dynamic accuracy thresholds allow the system to reduce those computing costs by autonomously discarding the queries to the least accurate generative engines based on the query (prompt), thereby making the process faster, avoiding bottlenecks, reducing network bandwidth, reducing CPU usage, reducing memory usage, etc. For example, based on FIG. 11, where a person sends a prompt asking for a table as the output, the dynamic accuracy threshold system does not send the prompt to generative AI engine C (e.g., having a 75% accuracy score for tables), which is most prone to hallucinate or provide inaccurate results for this type of output.

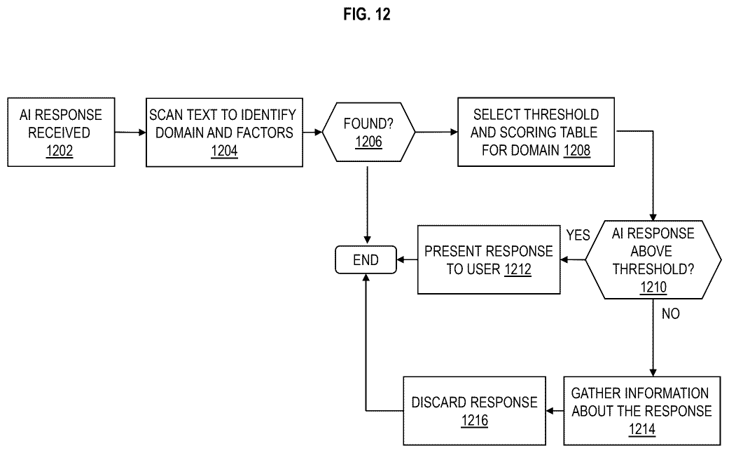

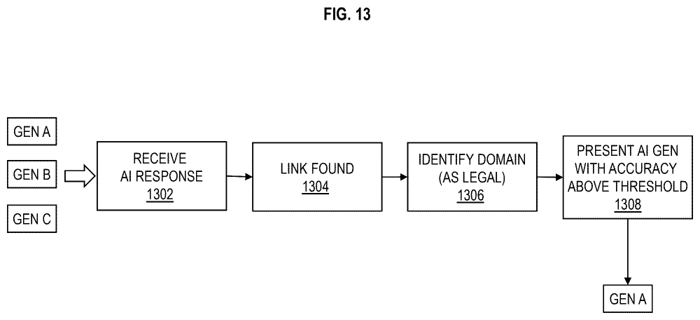

FIG. 12 depicts a flowchart of a computer-implemented method 1200 for dynamically (in real-time or near real-time) filtering AI responses, thereby providing output-based analysis according to one or more embodiments. At block 1202, the software 204 is configured to receive an AI response. At block 1204, the software 204 is configured to scan the AI response to identify the domain and for factors (such as links, uniform resource locators (URLs), citations, etc., which are discussed further in FIG. 13). The software 204 may employ the NLP 264 to determine the topic of the AI response. The software 204 can compare the topic of the AI response to the predetermined domains (or predetermined categories of the domains) to find a match. At block 1206, the software 204 can check if a domain or factor is found in the AI responses. If there is no domain or factor found, the flow ends. At block 1208, the software 204 is configured to select the threshold 284 and scoring table 282 that correspond to the domain. At block 1210, the software 204 is configured to check whether the generative AI engine having output the AI response has an accuracy score that meets and/or exceeds the corresponding threshold 284. At block 1212, when the accuracy score meets and/or exceeds the corresponding threshold 284, the software 204 is configured to present the AI response to the user of user device 252. At blocks 1214 and 1216, when the accuracy score does not meet and/or exceed the corresponding threshold 284, the software 204 gathers the information regarding the AI response and discards the AI response without presenting it to the user.

FIG. 13 depicts a flowchart of a computer-implemented method 1300 for dynamically (in real-time or near real-time) filtering AI responses having links, thereby providing output-based analysis according to one or more embodiments. At blocks 1302 and 1304, the software 204 is configured to receive an AI response and determine that one or more links are found. At block 1306, the software 204 is configured to identify the domain of the AI response along with the associated threshold. At block 1308, the software 204 is configured to present the generative AI engine with the links when the accuracy score of the generative AI engine has an accuracy score meeting and/exceeding the threshold. Otherwise, the links are discarded. For example, if the domain is legal and links refer to citations, the threshold for the accuracy score of the generative AI engine may be relatively high.

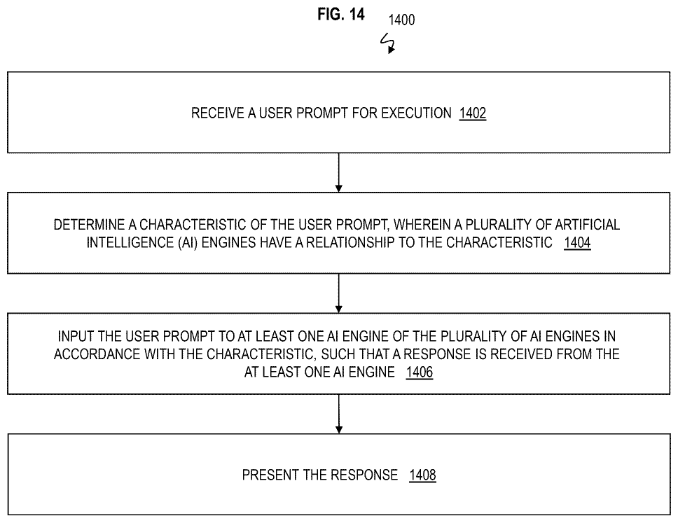

FIG. 14 depicts a flowchart of a computer-implemented method 1400 for dynamically (in real-time or near real-time) providing an accuracy determination for generative AI engines, by selecting and executing the most accurate generative AI engines and then presenting the responses of the generative AI engines to the user according to one or more embodiments. Reference can be made to any figures discussed herein.

At blocks 1402 and 1404 of the computer-implemented method 1400, the software 204 is configured to receive a user prompt for execution and determine a characteristic of the user prompt. Artificial intelligence (AI) engines (e.g., generative AI engines 244) have a relationship to the characteristic. The characteristic relates to and/or defines an aspect of the user prompt. The characteristic can be a domain of the user prompt. The characteristic can be a topic and/or output type of the user prompt. The characteristic can include the subject matter of the user prompt. The user prompt can be captured as a data structure. At block 1406, the software 204 is configured to input the user prompt to at least one AI engine of the plurality of AI engines in accordance with the characteristic, such that a response is received from the at least one AI engine. The at least one AI engine can represent the selection of one or more generative AI engines 244. At block 1408, the software 204 is configured to present the response to the user on the user device 252.

The characteristic comprises a topic of the user prompt. The characteristic comprises a type of output requested for the user prompt. The software 204 can cause the execution/performance of natural language processing (NLP) to determine a topic of the user prompt.

The plurality of AI engines have scores for the characteristic, and the software is configured to select the at least one AI engine from the plurality of AI engines based on the at least one AI engine having a higher score for the characteristic. The at least one AI engine is selected based on having a high probability of accuracy (e.g., the best accuracy) for the characteristic compared to the other/remaining AI engines. Example scores/probabilities of accuracy are depicted in FIGS. 10 and 11.

The at least one AI engine has a score for the characteristic, and the software 204 is configured to update the score for the characteristic based on an inaccuracy being in one or more responses from the at least one AI engine. FIG. 3 depicts decreasing the score based on inaccuracies per domain.

The user prompt is received from a user, and the characteristic comprises one or more of a role of the user, an organization of the user, or a location of the user. Reference can be made to FIGS. 6, 7, 8, and 9.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 15, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 15 are intended to be illustrative only and that computing nodes 10 and cloud computing environment 50 can communicate with any type of computerized device over any type of network and/or network addressable connection (e.g., using a web browser).

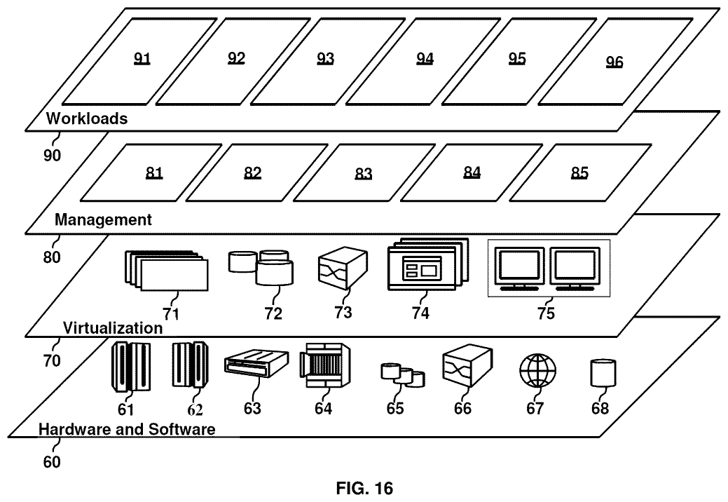

Referring now to FIG. 16, a set of functional abstraction layers provided by cloud computing environment 50 (depicted in FIG. 15) is shown. It should be understood in advance that the components, layers, and functions shown in FIG. 16 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the software 204, ranking software 262, NLP 264, generative AI engines 244, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect.

Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a user prompt for execution;
determining a characteristic of the user prompt, wherein a plurality of artificial intelligence (AI) engines have a relationship to the characteristic;
inputting the user prompt to at least one AI engine of the plurality of AI engines in accordance with the characteristic, such that a response is received from the at least one AI engine; and
presenting the response.

2. The computer-implemented method of claim 1, wherein the characteristic comprises a topic of the user prompt.

3. The computer-implemented method of claim 1, wherein the characteristic comprises a type of output requested for the user prompt.

4. The computer-implemented method of claim 1, further comprising performing natural language processing (NLP) to determine a topic of the user prompt.

5. The computer-implemented method of claim 1, wherein the plurality of AI engines have scores for the characteristic;
further comprising selecting the at least one AI engine from the plurality of AI engines based on the at least one AI engine having a higher score for the characteristic.

6. The computer-implemented method of claim 1, wherein the at least one AI engine has a score for the characteristic;
further comprising updating the score for the characteristic based on an inaccuracy being in one or more responses from the at least one AI engine.

7. The computer-implemented method of claim 1, wherein:
the user prompt is received from a user; and
the characteristic comprises one or more of a role of the user, an organization of the user, or a location of the user.

8. A system comprising:
a memory having computer readable instructions; and
one or more processors for executing the computer readable instructions, the computer readable instructions when executed cause the one or more processors to perform operations comprising:
receiving a user prompt for execution;
determining a characteristic of the user prompt, wherein a plurality of artificial intelligence (AI) engines have a relationship to the characteristic;
inputting the user prompt to at least one AI engine of the plurality of AI engines in accordance with the characteristic, such that a response is received from the at least one AI engine; and
presenting the response.

9. The system of claim 8, wherein the characteristic comprises a topic of the user prompt.

10. The system of claim 8, wherein the characteristic comprises a type of output requested for the user prompt.

11. The system of claim 8, wherein the one or more processors perform the operations further comprising performing natural language processing (NLP) to determine a topic of the user prompt.

12. The system of claim 8, wherein:
the plurality of AI engines have scores for the characteristic; and
the one or more processors perform the operations further comprising selecting the at least one AI engine from the plurality of AI engines based on the at least one AI engine having a higher score for the characteristic.

13. The system of claim 8, wherein:
the at least one AI engine has a score for the characteristic; and
the one or more processors perform the operations further comprising updating the score for the characteristic based on an inaccuracy being in one or more responses from the at least one AI engine.

14. The system of claim 8, wherein:
the user prompt is received from a user; and
the characteristic comprises one or more of a role of the user, an organization of the user, or a location of the user.

15. A computer program product comprising a computer readable storage medium having program instructions embodied therewith, the program instructions executable by one or more processors to cause the one or more processors to perform operations comprising:
receiving a user prompt for execution;
determining a characteristic of the user prompt, wherein a plurality of artificial intelligence (AI) engines have a relationship to the characteristic;
inputting the user prompt to at least one AI engine of the plurality of AI engines in accordance with the characteristic, such that a response is received from the at least one AI engine; and
presenting the response.

16. The computer program product of claim 15, wherein the characteristic comprises a topic of the user prompt.

17. The computer program product of claim 15, wherein the characteristic comprises a type of output requested for the user prompt.

18. The computer program product of claim 15, further comprising performing natural language processing (NLP) to determine a topic of the user prompt.

19. The computer program product of claim 15, wherein the plurality of AI engines have scores for the characteristic;
further comprising selecting the at least one AI engine from the plurality of AI engines based on the at least one AI engine having a higher score for the characteristic.

20. The computer program product of claim 15, wherein the at least one AI engine has a score for the characteristic;
further comprising updating the score for the characteristic based on an inaccuracy being in one or more responses from the at least one AI engine.
